(19) United States
(12) Patent Application Publication
(10) Pub. No.: US 2026/0024159 A1
(43) Pub. Date: Jan. 22, 2026

(54) Watermark Extraction Method, Model Training Method, Watermark Addition Method, and Electronic Apparatus

(71) Applicant: BOE TECHNOLOGY GROUP CO., LTD., Chaoyang District, Beijing (CN)

(72) Inventors: Feng Hou, Beijing (CN); Hao Fang, Beijing (CN)

(21) Appl. No.: 18/995,054

(22) PCT Filed: May 14, 2024
(86) PCT No.: PCT/CN2024/093155

§ 371 Date: Jan. 15, 2025

(30) Foreign Application Priority Data
Jun. 16, 2023 (CN) 202310721591.0

(51) Int. Cl. G06T 1/00; G06T 3/02

(52) U.S. Cl. CPC G06T 1/0028; G06T 3/02; G06T 2201/0065

(57) ABSTRACT

The present disclosure provides a watermark extraction method, a model training method, a watermark addition method and an electronic device. The watermark extraction method includes the following steps acquiring an image to be processed embedded with a watermark, wherein the watermark includes a plurality of positioning blocks and a plurality of information blocks; identifying the image to be processed by a first identification model to identify at least part of positioning blocks among the plurality of the positioning blocks; deforming the image to be processed according to a current position relationship of the at least part of positioning blocks and a reference position relationship of the at least part of positioning blocks; extracting the plurality of information blocks from the deformed image to be processed; and identifying the plurality of the information blocks by a second identification model to obtain the watermark carried by the plurality of information blocks.

### CROSS-REFERENCE TO RELATED APPLICATIONS

This application is the United States national phase of International Patent Application No. PCT/CN2024/093155, filed May 14, 2024, and claims priority to Chinese Patent Application No. 202310721591.0, filed Jun. 16, 2023, the disclosures of which are hereby incorporated by reference in their entireties.

### BACKGROUND OF THE INVENTION

### Field of the Invention

The present disclosure relates to the field of information technology, and in particular to a watermark extraction method, a model training method, a watermark addition method and an electronic device.

### Description of Related Art

Description Of Related ArtIn order to extract a watermark embedded in an image, a user uses an image acquisition device to acquire the currently presented image, and then uses a trained machine learning model to identify the acquired image to extract the watermark embedded in the image.

### SUMMARY OF THE INVENTION

According to a first aspect of an embodiment of the present disclosure, there is provided a watermark extraction method, comprising: acquiring an image to be processed embedded with a watermark, wherein the watermark comprises a plurality of positioning blocks and a plurality of information blocks; identifying the image to be processed by a first identification model to identify at least part of positioning blocks among the plurality of the positioning blocks; deforming the image to be processed to obtain a deformed image to be processed according to a current position relationship of the at least part of the positioning blocks and a reference position relationship of the at least part of the positioning blocks in a case where a number of the at least part of the positioning blocks is greater than a preset threshold, wherein in the deformed image to be processed, a current position relationship of the plurality of the positioning blocks is consistent with a reference position relationship of the plurality of the positioning blocks; extracting the plurality of the information blocks from the deformed image to be processed according to the reference position relationship of the plurality of the positioning blocks; and identifying the plurality of the information blocks by a second identification model to obtain the watermark carried by the plurality of the information blocks.

In some embodiments, the identifying the image to be processed by the first identification model comprises: encoding the image to be processed by an encoder in the first identification model to obtain a plurality of first encoding feature vectors, wherein in the plurality of the first encoding feature vectors, a weight of a first encoding feature vector associated with the positioning block is greater than a weight of a first encoding feature vector associated with the information block; decoding the plurality of the encoding feature vectors by a decoder in the first identification model to obtain a plurality of first decoding feature vectors; and identifying the at least part of positioning blocks according to the plurality of the first decoding feature vectors.

In some embodiments, a weight of a first decoding feature vector associated with the positioning block is greater than a weight of a first decoding feature vector associated with the information block in the plurality of the first decoding feature vectors.

In some embodiments, the identifying the plurality of the information blocks by the second identification model comprises: encoding each information block among the plurality of the information blocks by an encoder in the second identification model to obtain a second encoding feature vector; decoding the second encoding feature vector by a decoder in the second identification model to obtain a second decoding feature vector; and obtaining the watermark of the each information block according to the second decoding feature vector.

In some embodiments, the encoder in the second identification model comprises a plurality of sub-encoders connected in sequence, and the encoding the each information block among the plurality of the information blocks by the encoder in the second identification model comprises: processing an input feature vector of an i-th sub-encoder by the i-th sub-encoder; and taking an output feature vector of the i-th sub-encoder as an input feature vector of an (i+1)-th sub-encoder, wherein an input feature vector of a first sub-encoder is an embedded feature vector of the each information block, and an output feature vector of a n-th sub-encoder is the second encoding feature vector, where 1≤i<N, and N is a total number of the sub-encoders.

In some embodiments, each sub-encoder among the plurality of the sub-encoders comprises a plurality of self-attention models, and the processing the input feature vector of the i-th sub-encoder by the i-th sub-encoder comprises: processing the input feature vector of the i-th sub-encoder by each self-attention model among the plurality of the self-attention models in the i-th sub-encoder to obtain a sub-feature vector, thereby obtaining a plurality of sub-feature vectors; and fusing the plurality of the sub-feature vectors to obtain the output feature vector of the i-th sub-encoder.

In some embodiments, the fusing the plurality of the sub-feature vectors comprises: splicing the plurality of sub-feature vectors.

In some embodiments, the deforming the image to be processed comprises: determining an affine transformation parameter according to the current position relationship of the at least part of positioning blocks and the reference position relationship of the at least part of positioning blocks; and performing affine transformation on the image to be processed according to the affine transformation parameter to obtain the deformed image to be processed.

According to a second aspect of an embodiment of the present disclosure, there is provided a model training method, comprising: acquiring a sample image embedded with a watermark, wherein the watermark comprises a plurality of positioning blocks and a plurality of information blocks; identifying the sample image by a first identification model to identify at least part of positioning blocks among the plurality of the positioning blocks; training the first identification model according to the at least part of positioning blocks and positioning block labeling information; deforming the sample image to obtain a deformed sample image according to a current position relationship of the at least part of positioning blocks and a reference position relationship of the at least part of positioning blocks in a case where a number of the at least part of positioning blocks is greater than a preset threshold, wherein in a deformed sample image, a current position relationship of the plurality of the positioning blocks is consistent with a reference position relationship of the plurality of the positioning blocks; extracting the plurality of the information blocks from the deformed sample image according to the reference position relationship of the plurality of the positioning blocks; identifying the plurality of the information blocks by a second identification model to obtain the watermark carried by the plurality of the information blocks; and training the second identification model according to the watermark and watermark labeling information.

In some embodiments, the identifying the sample image by the first identification model comprises: preprocessing the sample image to obtain a plurality of enhanced sample images, wherein the preprocessing comprises at least one of color temperature adjustment or saturation adjustment; and identifying each enhanced sample image among the plurality of the enhanced sample images by the first identification model.

In some embodiments, the preprocessing the sample image comprises: filtering the sample image; and performing the preprocessing on the filtered sample image.

In some embodiments, the identifying the plurality of the information blocks by the second identification model comprises: sorting the plurality of the information blocks in a plurality of different orders to obtain a plurality of queues; and identifying a plurality of information blocks in each queue among the plurality of the queues by the second identification model to obtain the watermark.

According to a third aspect of an embodiment of the present disclosure, there is provided a watermark addition method, comprising: generating a watermark, wherein the watermark comprises a plurality of positioning blocks and a plurality of information blocks, in which the plurality of the positioning blocks have a reference position relationship, and the plurality of the information blocks carry watermark to be added; and embedding the watermark in a designated area of a target image.

In some embodiments, the plurality of the information blocks comprise a plurality of first information blocks for representing a first character and a plurality of second information blocks for representing a second character.

In some embodiments, the embedding the watermark in the designated area of the target image comprises: overlaying the watermark with an image in the designated area of the target image.

In some embodiments, colors of the positioning block, the first information block and the second information block are colors insensitive to human vision and are different from each other.

In some embodiments, colors of any two blocks in the positioning block, the first information block and the second information block are insensitive to human vision and are different from each other, and one block in the positioning block, the first information block and the second information block except for the any two blocks is colorless.

In some embodiments, the designated area comprises a first sub-area corresponding to the plurality of the positioning blocks, a second sub-area corresponding to the plurality of the first information blocks and a third sub-area corresponding to the plurality of the second information blocks, and the embedding the watermark in the designated area of the target image comprises: selecting two sub-areas from the first sub-area, the second sub-area and the third sub-area; determining a first parameter value according to an average gray value of pixels of one sub-area of the two sub-areas; adjusting a gray value of each pixel in the one sub-area of the two sub-areas according to the first parameter value; determining a second parameter value according to an average gray value of pixels of the other sub-area of the two sub-areas, wherein the second parameter value is different from the first parameter value; and adjusting a gray value of each pixel in the other sub-area of the two sub-areas according to the second parameter value.

In some embodiments, the embedding the watermark in the designated area of the target image comprises: determining a third parameter value according to an average gray value of pixels of a remaining sub-area in the first sub-area, the second sub-area and the third sub-area except for the two sub-areas, wherein the third parameter value is different from the first parameter value and the second parameter value; and adjusting a gray value of each pixel in the remaining sub-area according to the third parameter value.

In some embodiments, the designated area comprises a plurality of sub-areas, and the embedding the watermark in the designated area of the target image comprises: embedding the watermark in each sub-area among the plurality of sub-areas.

According to a fourth aspect of an embodiment of the present disclosure, there is provided an electronic device comprising: a processor; and a memory coupled to the processor, storing program instructions which, when executed by the processor, cause the processor to implement the method according to the method as described in any of the above embodiments.

According to a fifth aspect of an embodiment of the present disclosure, there is provided a non-transient computer-readable storage medium, wherein the computer-readable storage medium stores computer instructions which, when executed by a processor, implement the method as described in any of the above embodiments.

Other features and advantages of the present disclosure will become clear through detailed descriptions of the illustrative embodiments of the present disclosure with reference to the following accompanying drawings.

### BRIEF DESCRIPTION OF THE DRAWINGS

The accompanying drawings, which form a part of the specification, illustrate embodiments of the disclosure and together with the specification, serve to explain the principles of the disclosure.

The present disclosure can be more clearly understood from the following detailed description with reference to the accompanying drawings, in which:

FIG. 1 is a flow schematic diagram of a watermark extraction method according to one embodiment of the present disclosure;

FIG. 2 is a schematic diagram of a watermark according to one embodiment of the present disclosure;

FIG. 3 is a schematic diagram of a template library according to one embodiment of the present disclosure;

FIG. 4 is a structural schematic diagram of a first identification model according to one embodiment of the present disclosure;

FIG. 5A-FIG. 5C are schematic diagrams of affine transformation according to some embodiments of the present disclosure;

FIG. 6 is a structural schematic diagram of a second identification model according to one embodiment of the present disclosure;

FIG. 7 is a structural schematic diagram of an encoder according to one embodiment of the present disclosure;

FIG. 8 is a structural schematic diagram of a sub-encoder according to one embodiment of the present disclosure;

FIG. 9 is a flow schematic diagram of a model training method according to one embodiment of the present disclosure;

FIG. 10 is a flow schematic diagram of a watermark addition method according to one embodiment of the present disclosure;

FIG. 11 is a schematic diagram of an image embedded with a watermark according to one embodiment of the present disclosure;

FIG. 12 is a schematic diagram of an image embedded with a watermark according to another embodiment of the present disclosure;

FIG. 13 is a schematic structural diagram of an electronic device according to one embodiment of the present disclosure.

It shall be understood that the various parts shown in the accompanying drawings are not drawn in sizes according to actual proportional relations. In addition, the same or similar reference numerals indicate the same or similar components.

### DESCRIPTION OF THE INVENTION

The descriptions of the illustrative embodiments are only illustrative, but shall not serve as limitations on the present disclosure and its application or utilization. The present disclosure can be implemented in many different forms and is not limited to the embodiments described herein. These embodiments are provided to make the present disclosure thorough and complete, and to fully express the scope of the present disclosure to those skilled in the art. It should be noted that unless otherwise illustrated, the relative arrangements of the components and steps, the components of the materials, and values set forth in these embodiments are to be construed as illustrative only and not as a limitation.

The terms “first”, “second” and similar wordings used in the present disclosure do not mean any order, quantity or importance, but are used only to discriminate different parts. The words “include” or “comprise” and the like mean that the elements preceding the word contain the elements listed after the word, and do not exclude the possibility of containing other elements.

All terms (including technical or scientific terms) used in the present disclosure have the same meaning as those understood by one ordinary skilled in the art to which the present disclosure belongs, unless specifically defined otherwise. It shall be further understood that, the terms as defined in a common dictionary shall be interpreted as having meanings consistent with those in the context of the relevant technique, instead of being interpreted with an idealistic or extremely formalized meaning, unless it is explicitly defined here.

Techniques, methods and devices that have already been known to ordinary skilled in the art may not be discussed here in details, but under appropriate circumstances, the techniques, methods and devices shall be deemed as parts of the description.

The inventors found that in the process of acquiring a currently presented image by the image acquisition device, the acquired image is usually deformed due to the acquisition angle, thereby increasing the difficulty for identifying the watermark and reducing the success rate of the extraction of the watermark.

Accordingly, the present disclosure provides a watermark extraction solution, which can effectively extract the watermark embedded in the deformed image.

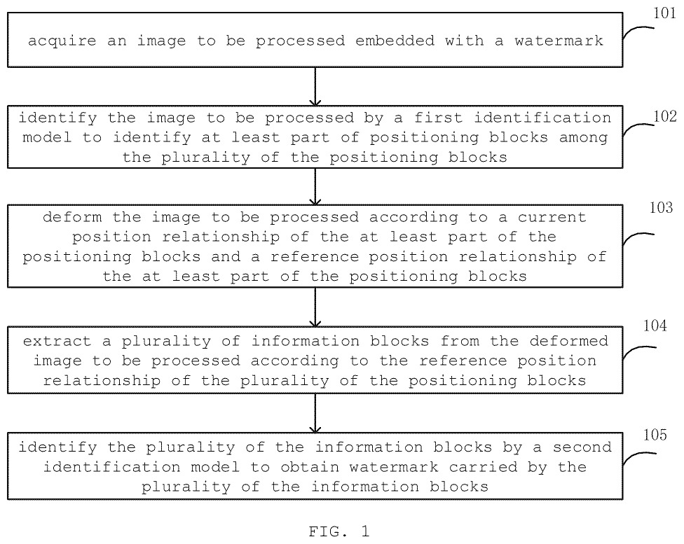

FIG. 1 is a flow schematic diagram of a watermark extraction method according to one embodiment of the present disclosure. In some embodiments, the watermark extraction method is performed by a watermark extraction device.

In step 101, an image to be processed embedded with a watermark is acquired, wherein the watermark comprises a plurality of positioning blocks and a plurality of information blocks.

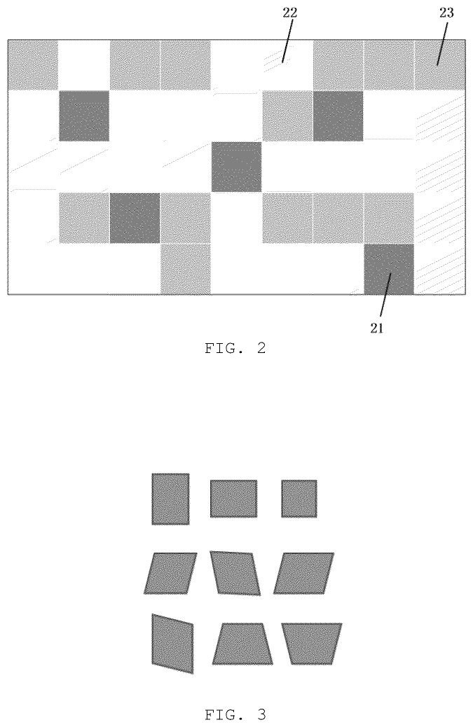

For example, the currently presented image is embedded with a watermark. The user uses an image acquisition device to acquire the currently presented image to obtain the image to be processed. The watermark embedded in the image to be processed is shown in FIG. 2.

In FIG. 2, the watermark includes a plurality of image blocks. The plurality of image blocks include a plurality of positioning blocks 21 and a plurality of information blocks. The plurality of information blocks include a plurality of information blocks 22 corresponding to the character “0” and a plurality of information blocks 23 corresponding to the character “1”.

In some embodiments, the image to be processed is filtered to remove moire patterns generated when acquiring the image to be processed through acquiring, after the image to be processed embedded with a watermark is acquired.

For example, the filtering processing includes median filtering, mean filtering and other filtering processing methods.

In step 102, the image to be processed is identified by a first identification model, thereby identifying at least part of positioning blocks among the plurality of positioning blocks.

In some embodiments, the image to be processed is encoded by an encoder in the first identification model to obtain a plurality of first encoding feature vectors, wherein in the plurality of first encoding feature vectors, the weight of the first encoding feature vector associated with the positioning block is greater than the weight of the first encoding feature vector associated with the information block. Next, the plurality of encoding feature vectors are decoded by a decoder in the first identification model to obtain a plurality of first decoding feature vectors, and then the at least part of positioning blocks is identified from the plurality of first decoding feature vectors.

It should be noted here that because the image to be processed is deformed, the positioning block embedded in the watermark in the image to be processed is also deformed. For example, the original shape of a positioning block is square, and the positioning block may become a rectangle, a diamond, a trapezoid or a quadrilateral of other shapes after deformation, as shown in FIG. 3.

Accordingly, in order to improve the identification success rate of the positioning block, quadrilateral templates with various shapes as shown in FIG. 3 are set in the preset template library. In the process of encoding the image to be processed by the encoder, the weight of the encoding feature vector matched with the template feature vector in the template library is increased, thereby improving the identification success rate of the positioning block.

In some embodiments, among a plurality of first decoding feature vectors, the weight of the first decoding feature vector associated with the positioning block is greater than the weight of the first decoding feature vector associated with the information block.

It should be noted here that in the process of decoding a plurality of encoding feature vectors by the decoder, the weight of the first decoding feature vector matched with the template feature vector in the template library is further increased, so as to further improve the identification success rate of the positioning blocks.

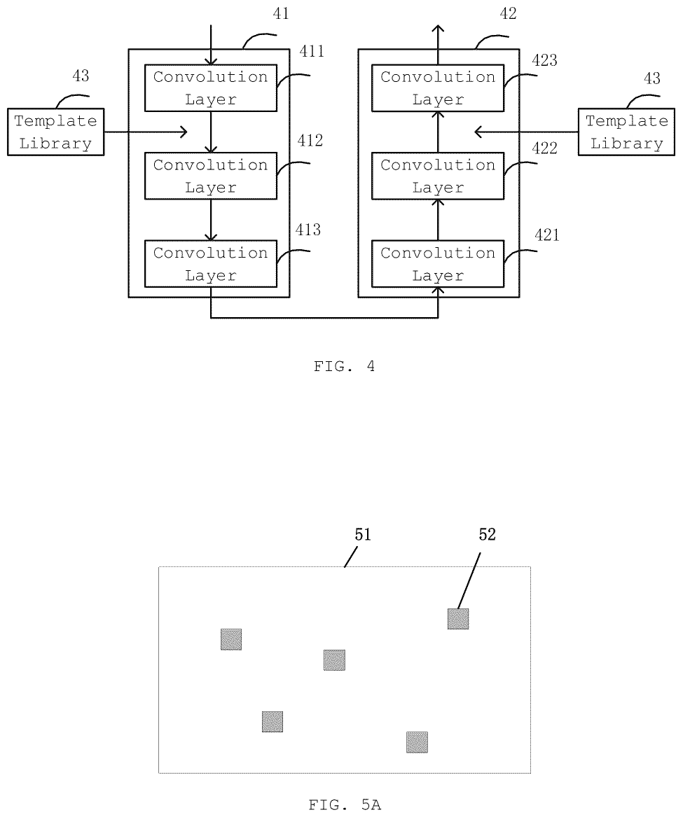

FIG. 4 is a schematic diagram of a first identification model according to one embodiment of the present disclosure. As shown in FIG. 4, the first identification model includes an encoder 41 and a decoder 42. The encoder 41 includes three convolution layers 411-413 connected in sequence, and the decoder 42 includes three convolution layers 421-423 connected in sequence. In the encoder 41, the output of the specified convolution layer is weighted. For example, for the encoding feature vectors output by the convolution layer 411, the weight of the encoding feature vector matched with the template feature vector in the template library 43 is increased. In the decoder 42, the output of the specified convolution layer is weighted. For example, for the decoding feature vectors output by the convolution layer 422, the weight of the decoding feature vector matched with the template feature vector in the template library 43 is increased.

It should be noted that for the sake of conciseness, only three convolution layers are shown in the encoder 41 and the decoder 42. Those skilled person in the art can adjust the number of the convolution layers in the encoder 41 and the decoder 42 as needed.

In step 103, in a case where the number of the at least part of positioning blocks is greater than a preset threshold, deformation process is performed on the image to be processed according to the current position relationship of the at least part of positioning blocks and the reference position relationship of the at least part of positioning blocks, such that in the deformed image to be processed, the current position relationship of the plurality of positioning blocks is consistent with the reference position relationship of the plurality of positioning blocks.

In some embodiments, affine transformation parameter is determined according to the current position relationship of the at least part of positioning blocks and the reference position relationship of the at least part of positioning blocks, and affine transformation is performed on the image to be processed according to the affine transformation parameter to obtain the deformed image to be processed.

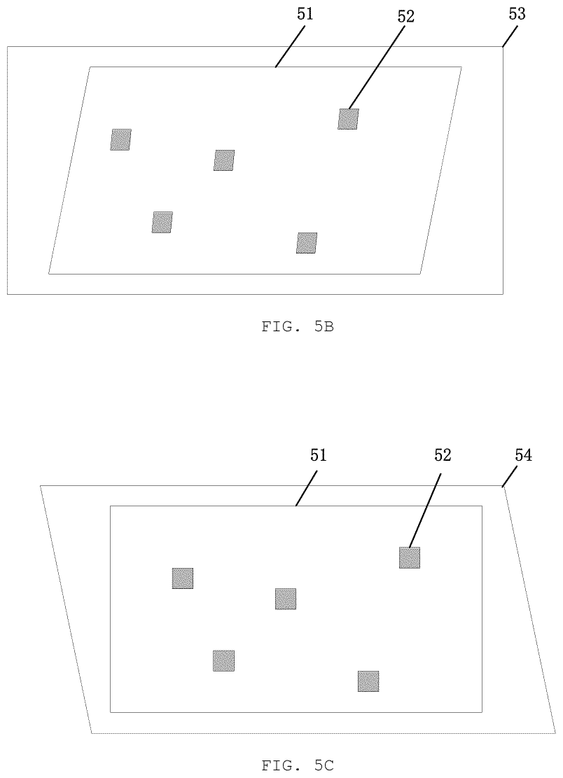

For example, as shown in FIG. 5A, a watermark 51 embedded in an image is provided with five positioning blocks 52. The user acquires the image displayed on the screen, and the obtained image 53 to be processed is shown in FIG. 5B. As can be seen from FIG. 5B, the watermark 51 is changed from a rectangle to a diamond, that is, the watermark 51 has been deformed. If four of the five positioning blocks in the watermark 51 are identified, the affine transformation parameter is determined according to the position relationship between the four positioning blocks and the position relationship between the four positioning blocks and the four vertices of the watermark, and then affine transformation is performed on the image 53 to be processed according to the affine transformation parameter to obtain a deformed image 54 to be processed, as shown in FIG. 5C.

Therefore, after the affine transformation, the position relationship of the five positioning blocks 52 in FIG. 5C is consistent with the reference position relationship of the five positioning blocks 52 in FIG. 5A, thus effectively overcoming the deformation problem of the watermark 51 and contributing to the effective extraction of watermark.

It should be noted that in a case where the number of at least part of positioning blocks is greater than the preset threshold, the correct affine transformation parameter can be obtained only according to the at least part of positioning blocks, and in this case, deformation process can be performed on the image to be processed. On the contrary, if the number of the identified positioning blocks is small, the correct affine transformation parameter cannot be obtained, and in this case, correct deformation processing cannot be performed on the image to be processed.

In step 104, a plurality of information blocks are extracted from the deformed image to be processed according to the reference position relationship of the plurality of positioning blocks.

It should be noted that the reference position relationship of a plurality of positioning blocks in the watermark is determined in advance, therefore according to the reference position relationship of the plurality of positioning blocks, the plurality of information blocks can be extracted from the deformed image to be processed.

For example, according to the reference position relationship of a plurality of positioning blocks 21 in FIG. 2, a plurality of information blocks 22 corresponding to the character “0” and a plurality of information blocks 23 corresponding to the character “1” can be extracted from FIG. 2.

In step 105, the plurality of information blocks are identified by a second identification model to obtain watermark carried by the plurality of information blocks.

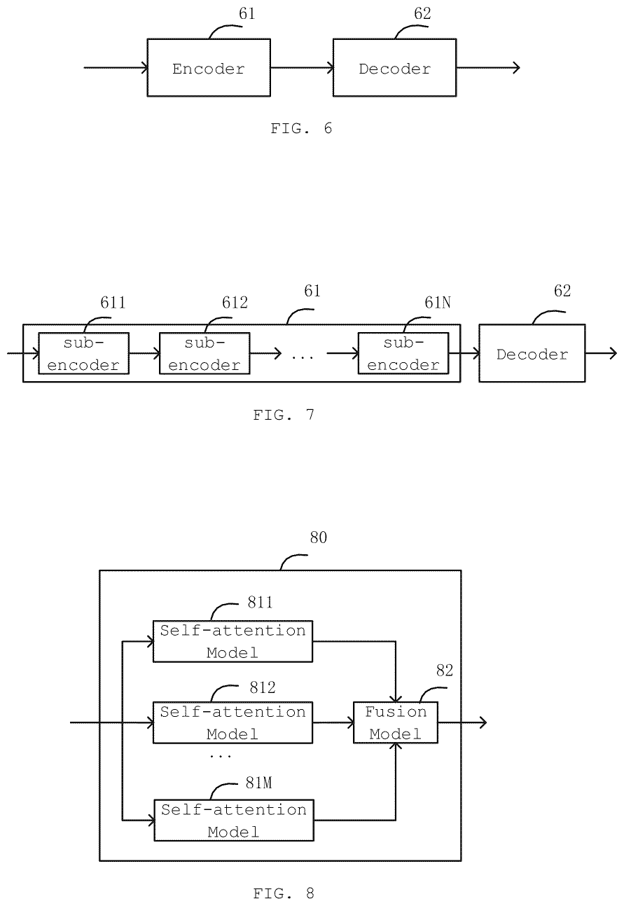

FIG. 6 is a schematic diagram of a second identification model according to one embodiment of the present disclosure. As shown in FIG. 6, the second identification model includes an encoder 61 and a decoder 62.

First, each information block among the plurality of information blocks is encoded by the encoder 61 in the second identification model, thereby obtaining a second encoding feature vector. Next, the second encoding feature vector is decoded by the decoder 62 in the second identification model to obtain a second decoding feature vector, and then the watermark of each information block is obtained according to the second decoding feature vector.

FIG. 7 is a schematic diagram of an encoder in a second identification model according to one embodiment of the present disclosure. As shown in FIG. 7, the encoder 61 includes a plurality of sub-encoders 611, 612, . . . , 61N connected in sequence. By setting a plurality of sub-encoders, the identification success rate of watermark can be further improved.

As shown in FIG. 7, the input feature vector of the sub-encoder 611 is processed by the sub-encoder 611, and the output feature vector of the sub-encoder 611 is taken as the input feature vector of the sub-encoder 612. The input feature vector of the sub-encoder 612 is processed by the sub-encoder 612, and the output feature vector of the sub-encoder 612 is taken as the input feature vector of the next sub-encoder, and so on. The input feature vector of the sub-encoder 611 is the embedded feature vector of each information block, and the output feature vector of the sub-encoder 61N is the second encoding feature vector.

In some embodiments, a plurality of self-attention models are set in each sub-encoder, in which different self-attention models are used to extract feature vectors of different dimensions, thus further improving the identification success rate of watermark.

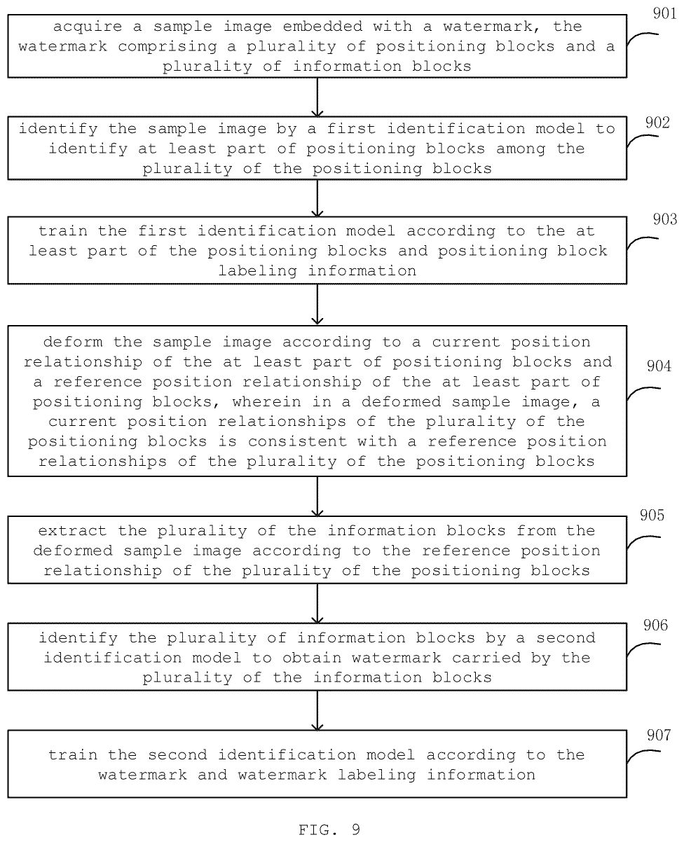

FIG. 8 is a structural schematic diagram of a sub-encoder according to one embodiment of the present disclosure. As shown in FIG. 8, a sub-encoder 80 includes a plurality of self-attention models 811, 812, . . . , 81M, and a fusion model 82. Each self-attention model among the plurality of self-attention models 811, 812, . . . , 81M processes the input feature vector of the sub-encoder 80 to obtain a sub-feature vector, thereby obtaining a plurality of sub-feature vectors. Next, the plurality of sub-feature vectors are fused by the fusion model 82 to obtain the output feature vector of the sub-encoder 80.

In some embodiments, the fusion model 82 splices the plurality of sub-feature vectors to obtain the output feature vector of the sub-encoder 80.

In some embodiments, the watermark is further decrypted by a specified key to obtain plaintext information after the watermark carried by a plurality of information blocks is obtained.

For example, the obtained watermark is “01011101010100010101”, which is decrypted by the specified key to obtain the device number and time information.

In the watermark extraction method provided in the above embodiments of the present disclosure, deformation process is performed on the image to be processed according to the current position relationship of a plurality of positioning blocks in the watermark, such that in the deformed image to be processed, the current position relationship of the plurality of positioning blocks is consistent with the reference position relationship of the plurality of positioning blocks. On this basis, a plurality of information blocks extracted from the image to be processed are identified, so that the watermark embedded in the deformed image can be effectively extracted.

FIG. 9 is a flow schematic diagram of a model training method according to one embodiment of the present disclosure. In some embodiments, the following model training method is performed by a model training device.

In step 901, a sample image embedded with a watermark is acquired, wherein the watermark includes a plurality of positioning blocks and a plurality of information blocks.

In step 902, the sample image is identified by the first identification model, thereby identifying at least part of positioning blocks among the plurality of positioning blocks.

In some embodiments, the first identification model is shown in any of the embodiments in FIG. 4.

In some embodiments, the sample image is preprocessed to obtain a plurality of enhanced sample images, wherein the preprocessing comprises at least one of color temperature adjustment or saturation adjustment. Next, the first identification model is used to identify each enhanced sample image among the plurality of enhanced sample images.

It should be noted here that by performing preprocessing on the sample image, the number of sample images used for training can be effectively increased, and the generalization ability of the first identification model can be increased at the same time.

In some embodiments, in the process of the color temperature adjustment performed on the sample image, firstly, a gray world algorithm is used to perform white balance processing on the image to obtain the color temperature of the sample image. Next, the color temperature of the sample image is adjusted to obtain different sample images.

For example, the gray world algorithm is used to perform white balance processing on the image, and a color temperature of 6500K of the sample image is obtained. Next, the color temperature of the sample image is adjusted to 2000K, 4000K, 8000K and 10000K respectively, so that five sample images with different color temperatures are obtained.

In some embodiments, the process of saturation adjustment performed on the sample image is as follows:
1. An adjustment parameter percent is set. The value range of the adjustment parameter percent is [−100, 100], and after normalization, the value range of the adjustment parameter percent is [−1, 1].
2. For each pixel of the sample image, the maximum gray value Max and the minimum gray value Min in the R (Red) channel, G (Green) channel and B (Blue) channel are selected, and then the parameters delta and value are obtained, as shown in formulas (1) and (2).

$$delta = ( Max - Min ) / 255 \qquad ( 1 )$$

$$value = ( Max + Min ) / 255 \qquad ( 2 )$$

3. If delta=0, that is, the maximum gray value Max and the minimum gray value Min of a pixel are the same, it indicates that the pixel is a gray point. In this case, the pixel is not subjected to subsequent processing, otherwise, the subsequent processing is continued for the pixel.
4. The brightness value L of each pixel in the HSL (Hue, Saturation, Lightness) color space is calculate, as shown in Formula (3).

$$L = ( Max - Min ) / ( 2 \times 255 ) \qquad ( 3 )$$

5. The saturation S of each pixel in the HSL color space is calculate, as shown in Formula (4).

$$\{ \begin{matrix}S = delta / value & L < 0.5 \\ S = delta / ( 2 - value ) & L \geq 0. 5\end{matrix} \qquad ( 4 )$$

6. If the adjustment parameter percent is greater than or equal to 0, the color saturation needs to be improved. In this case, the parameter alpha is shown in Formula (5).

$$\{ \begin{matrix}alpha = S & percent + S \geq 1 \\ alpha = 1 - percent & others\end{matrix} \qquad ( 5 )$$

Therefore, the gray value R of the R channel, the gray value G of the G channel and the gray value B of the B channel of each pixel are shown in Formula (6), Formula (7) and Formula (8) after adjustment:

$$R = R + ( R ‐ L \times 255 ) \times alpha \qquad ( 6 )$$

$$G = G + ( G ‐ L \times 255 ) \times alpha \qquad ( 7 )$$

$$B = B + ( B ‐ L \times 255 ) \times alpha \qquad ( 8 )$$

7. If the adjustment parameter percent is less than 0, the color saturation needs to be reduced, that is, alpha=percent. At this time, the gray value R of the R channel, the gray value G of the G channel and the gray value B of the B channel of each pixel are shown in Formula (9), Formula (10) and Formula (11) after adjustment:

$$R = L \times 255 + ( R ‐ L \times 255 ) \times ( 1 + alpha ) \qquad ( 9 )$$

$$G = L \times 255 + ( G ‐ L \times 255 ) \times ( 1 + alpha ) \qquad ( 10 )$$

$$B = L \times 255 + ( B ‐ L \times 255 ) \times ( 1 + alpha ) \qquad ( 11 )$$

For example, the adjustment parameter percent is set to 0.2, 0.4, 0.6 and 0.8 respectively, and by saturation adjustment on the sample image through the above process, four sample images with different saturation can be obtained.

It should be noted that the above saturation adjustment process is only an example, and other methods can be used for saturation adjustment.

In some embodiments, the sample image is filtered first, and then the filtered sample image is preprocessed.

In some embodiments, after the sample image embedded with a watermark is acquired, the sample image is filtered to remove moire patterns generated when acquiring the sample image through acquiring.

For example, the filtering process includes median filtering, mean filtering and other filtering process methods.

In step 903, the first identification model is trained according to at part of positioning blocks and the positioning block labeling information.

For example, a loss function is determined according to the identification result of the positioning block and the positioning block labeling information in the sample image, and the first identification model is trained according to this loss function.

In step 904, the sample image is deformed according to the current position relationship of the at least part of positioning blocks and the reference position relationship of at least part of positioning blocks in a case where the number of the at least part of positioning blocks is greater than a preset threshold, such that in the deformed sample image, the current position relationship of a plurality of positioning blocks is consistent with the reference position relationship of a plurality of positioning blocks.

In some embodiments, affine transformation parameter is determined according to the current position relationship of the at least part of positioning blocks and the reference position relationship of the at least part of positioning blocks, and affine transformation is performed on the sample image according to the affine transformation parameter to obtain a deformed sample image.

In step 905, a plurality of information blocks are extracted from the deformed sample image according to the reference position relationship of a plurality of positioning blocks.

In step 906, a plurality of information blocks are identified by a second identification model to obtain watermark carried by the plurality of information blocks.

For example, according to the reference position relationship of the plurality of positioning blocks 21 in FIG. 2, the plurality of information blocks 22 corresponding to the character “0” and the plurality of information blocks 23 corresponding to the character “1” can be extracted from FIG. 2.

In some embodiments, the second identification model is shown in any of the embodiments in FIGS. 6-8.

In some embodiments, the plurality of information blocks are sorted in a plurality of different orders to obtain a plurality of queues. Next, the second identification model is used to identify a plurality of information blocks in each queue among the plurality of queues to obtain watermark.

It should be noted that each information block in the watermark corresponds to one character, either “0” or “1”. If the order of the information blocks input into the second identification model is different, the output result of the second identification model is also different. By arranging a plurality of information blocks in the watermark in different orders, more information block queues can be obtained, which not only increases the training data, but also helps to increase the generalization ability of the second identification model.

In step 907, the second identification model is trained according to the watermark and the watermark labeling information.

For example, the loss function is determined according to the identified watermark and watermark labeling information, and the second identification model is trained according to the loss function.

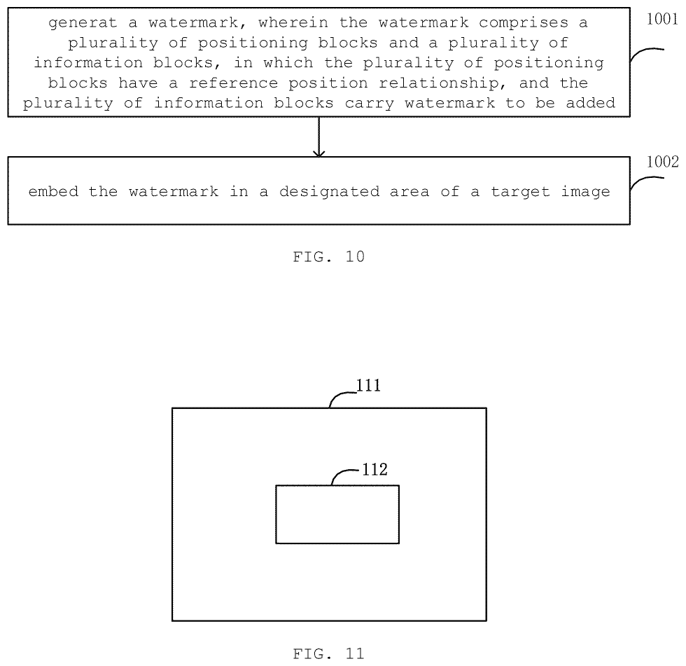

FIG. 10 is a flow schematic diagram of a watermark addition method according to one embodiment of the present disclosure. In some embodiments, the following watermark addition method is performed by a watermark addition device.

In step 1001, a watermark is generated, wherein the watermark comprises a plurality of positioning blocks and a plurality of information blocks, and the plurality of positioning blocks have a reference position relationship, and the plurality of information blocks carry watermark to be added.

In some embodiments, the plurality of information blocks include a plurality of first information blocks for representing a first character and a plurality of second information blocks for representing a second character. For example, the first character is “0” and the second character is “1”.

For example, the plaintext information is encrypted with a key to obtain the watermark to be added. Next, according to the preset encoding method, each character in the watermark is converted to obtain a plurality of information blocks.

As shown in FIG. 2, the watermark includes a plurality of image blocks. The plurality of image blocks include a plurality of positioning blocks 21 and a plurality of information blocks. Any two blocks in the plurality of positioning blocks and the plurality of information blocks do not overlap. The plurality of information blocks includes a plurality of information blocks 22 corresponding to the character “0” and a plurality of information blocks 23 corresponding to the character “1”.

In step 1002, a watermark is embedded in a designated area of a target image.

In some embodiments, the watermark is superimposed with an image in the designated area of the target image in order to add the watermark to the target image.

For example, the colors of the positioning block, the first information block and the second information block are colors insensitive to human vision and are different from each other. Therefore, the watermark embedded in the target image cannot be directly observed through human vision.

For another example, in the positioning block, the first information block and the second information block, the colors of any two blocks are insensitive to human vision and are different from each other, and one block in the positioning block, the first information block and the second information block except for the above two blocks is colorless. Therefore, the watermark embedded in the target image cannot be directly observed through human vision, at the same time, it is also conducive to identification of the watermark.

For example, the positioning block is blue-green, and the gray value is (0, 10, 10). The first information block is light blue with a gray value of (0, 0, 10). The second information block is colorless.

In some embodiments, the watermark is added to the target image by adjusting the pixel gray value in the designated area of the target image.

For example, the designated area of the target image includes a first sub-area corresponding to the plurality of positioning blocks, a second sub-area corresponding to the plurality of first information blocks and a third sub-area corresponding to the plurality of second information blocks. First, two sub-areas are selected from the first sub-area, the second sub-area and the third sub-area. Next, a first parameter value is determined according to the average gray value of pixels in one sub-area of the two sub-areas, and the gray value of each pixel in one sub-area of the two sub-areas is adjusted according to the first parameter value. Next, a second parameter value is determined according to the average gray value of pixels in the other sub-area of the two sub-areas, wherein the second parameter value is different from the first parameter value, and the gray value of each pixel in the other sub-area of the two sub-areas is adjusted according to the second parameter value.

For example, in the first sub-area, the second sub-area and the third sub-area, if the average gray value of pixels in the first sub-area is m1, the first parameter value δ1 is as shown in Formula (12).

$$δ1 = m 1 \times a / 255 \qquad ( 12 )$$

Where a is the adjustment value, for example, a=2. The original gray value of each pixel in the first sub-area is x1, then the adjusted gray value is x1′, as shown in Formula (13).

$$x {1}^{′} = x 1 + δ 1 \qquad ( 13 )$$

Next, if the average gray value of pixels in the second sub-area is m2, the second parameter value δ2 is as shown in Formula (14).

$$δ 2 = m 2 \times a / 255 \qquad ( 14 )$$

Where a is the adjustment value, for example, a=2. The original gray value of each pixel in the second sub-area is x2, then the adjusted gray value is x2′, as shown in Formula (15).

$$x {2}^{′} = x 2 - δ 2 \qquad ( 15 )$$

It should be noted that in this embodiment, the pixel gray value of the third sub-area is not adjusted.

That is, the watermark can also be added to the target image without overlaying the watermark with the image in the designated area of the target image.

In some embodiments, on the basis of adjusting the pixel gray values of two selected sub-areas in the first sub-area, the second sub-area and the third sub-area, the third parameter value is further determined according to the average gray value of pixels in the remaining sub-area in the first sub-area, the second sub-area and the third sub-area except for the two sub-areas, wherein the third parameter value is different from the first parameter value and the second parameter value, and the gray value of each pixel in the remaining sub-area is adjusted according to the third parameter value. That is to say, the pixel gray values of the first sub-area, the second sub-area and the third sub-area are all adjusted.

For example, on the basis of adjusting the pixel gray values of the first sub-area and the second sub-area, the pixel gray value of the third sub-area is adjusted. If the average gray value of pixels in the third sub-area is m3, the second parameter value δ3 is shown in Formula (16).

$$δ 3 = m 3 \times a / 255 \qquad ( 16 )$$

Where a is the adjustment value, for example, a=2. The original gray value of each pixel in the third sub-area is x3, then the adjusted gray value is x3′, as shown in Formula (17).

$$x {3}^{′} = x 3 + 2 \times δ 3 \qquad ( 17 )$$

By adjusting the pixel gray value of each sub-area, the watermark can be added to the target image, at the same time, it is more conducive to identification of the watermark.

In some embodiments, a watermark is added in the designated area of the target image.

FIG. 11 is a schematic diagram of an image embedded with a watermark according to an embodiment of the present disclosure. As shown in FIG. 11, an image 111 includes a designated area in which a watermark 112 is embedded.

In some embodiments, the designated area of the target image includes a plurality of sub-areas, and the watermark is embedded in each of the plurality of sub-areas.

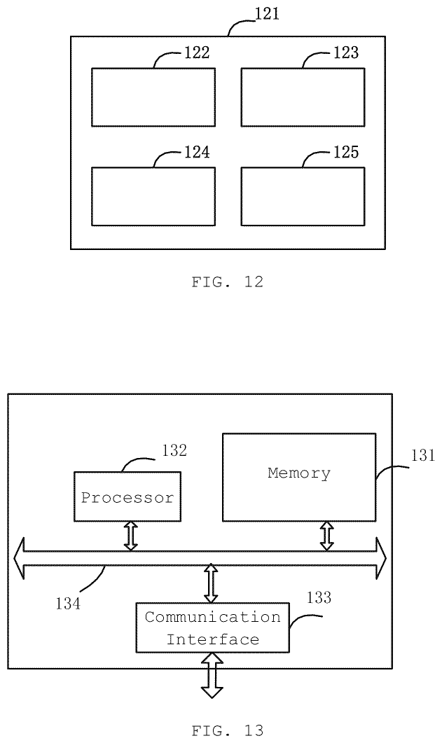

FIG. 12 is a schematic diagram of an image embedded with a watermark according to another embodiment of the present disclosure. The difference between FIG. 12 and FIG. 11 is that in the embodiment shown in FIG. 12, the designated area of an image 121 includes four sub-areas, and the watermark is embedded in each of the four sub-areas, so that the image 121 includes a watermark 122, a watermark 123, a watermark 124 and a watermark 125.

It should be noted that the watermark 122, the watermark 123, the watermark 124 and the watermark 125 are completely the same, therefore one of the watermark 122, the watermark 123, the watermark 124 and the watermark 125 is identified, the watermark can be obtained.

For example, if the image 122 is incomplete, the watermark carried by the watermark 122 cannot be successfully obtained, but the watermark can be obtained from one of the watermark 123, the watermark 124 and the watermark 125. Therefore, through the redundant setting of watermark, the success rate of acquisition of watermark is improved.

FIG. 13 is a structural schematic diagram of an electronic device according to one embodiment of the present disclosure. As shown in FIG. 13, the electronic device includes a memory 131 and a processor 132.

The memory 131 is used to store instructions. The processor 132 is coupled to the memory 131. The processor 132 is configured to implement the method according to any one of the embodiments in FIG. 1, FIG. 9 or FIG. 10 based on instructions stored in the memory.

For example, when the processor 132 implements the method according to any of the embodiments in FIG. 1 based on the instructions stored in the memory, the electronic device is used as a watermark extraction device. When the processor 132 implements the method according to any of the embodiments in FIG. 9 based on the instructions stored in the memory, the electronic device is used as a model training device. When the processor 132 implements the method according to any of the embodiments in FIG. 10 based on the instructions stored in the memory, the electronic device is used as a watermark addition device.

As shown in FIG. 13, the electronic device further includes a communication interface 133 for information interaction with other devices. Meanwhile, the electronic device also includes a bus 134 through which the processor 132, the communication interface 133 and the memory 131 communicate with each other.

The memory 131 may include a high-speed RAM (Random Access Memory) or a NVM (Non-Volatile Memory), such as at least one disk storage. The memory 131 may also be a memory array. The memory 131 may also be partitioned, and the blocks may be combined into a virtual volume according to certain rules.

In addition, the processor 132 may be a central processing unit, or may be an ASIC (Application Specific Integrated Circuit), or one or more integrated circuits configured to implement the embodiments of the present disclosure.

In some embodiments, the transparent display panel control device can be arranged in a SoC (System on Chip) board, an FPGA (Field Programmable Gate Array) board or a GPU (Graphics Processing Unit).

The present disclosure also provides a non-transient computer-readable storage medium. The computer-readable storage medium stores computer instructions, which, when executed by a processor, implement the method according to any one of the embodiments in FIG. 1, FIG. 9 or FIG. 10.

Heretofore, the embodiments of the present disclosure have been described in details. In order to avoid shielding of the concept of the present disclosure, some details commonly known in the art are not described. Based on the above description, those skilled in the art can fully understand how to carry out the technical solutions disclosed herein.

While some specific embodiments of the present disclosure have been described in details by way of examples, those skilled in the art should understand that the above examples are for illustrative purposes only and are not intended to limit the scope of the present disclosure. Those skilled in the art will appreciate that the above embodiments may be modified or an equivalent substitution may be performed on some of the technical features without departing from the scope and spirit of the present disclosure. The scope of the present disclosure is defined by the appended claims.

1. A watermark extraction method, comprising:
acquiring an image to be processed embedded with a watermark, wherein the watermark comprises a plurality of positioning blocks and a plurality of information blocks;
identifying the image to be processed by a first identification model to identify at least part of positioning blocks among the plurality of the positioning blocks;
deforming the image to be processed to obtain a deformed image to be processed according to a current position relationship of the at least part of the positioning blocks and a reference position relationship of the at least part of the positioning blocks in a case where a number of the at least part of the positioning blocks is greater than a preset threshold, wherein in the deformed image to be processed, a current position relationship of the plurality of the positioning blocks is consistent with a reference position relationship of the plurality of the positioning blocks;
extracting the plurality of the information blocks from the deformed image to be processed according to the reference position relationship of the plurality of the positioning blocks; and
identifying the plurality of the information blocks by a second identification model to obtain the watermark carried by the plurality of the information blocks.

2. The watermark extraction method according to claim 1, wherein the identifying the image to be processed by the first identification model comprises:
encoding the image to be processed by an encoder in the first identification model to obtain a plurality of first encoding feature vectors, wherein in the plurality of the first encoding feature vectors, a weight of a first encoding feature vector associated with the positioning block is greater than a weight of a first encoding feature vector associated with the information block;
decoding the plurality of the encoding feature vectors by a decoder in the first identification model to obtain a plurality of first decoding feature vectors; and
identifying the at least part of positioning blocks according to the plurality of the first decoding feature vectors.

3. The watermark extraction method according to claim 2, wherein
a weight of a first decoding feature vector associated with the positioning block is greater than a weight of a first decoding feature vector associated with the information block in the plurality of the first decoding feature vectors.

4. The watermark extraction method according to claim 1, wherein the identifying the plurality of the information blocks by the second identification model comprises:
encoding each information block among the plurality of the information blocks by an encoder in the second identification model to obtain a second encoding feature vector;
decoding the second encoding feature vector by a decoder in the second identification model to obtain a second decoding feature vector; and
obtaining the watermark of the each information block according to the second decoding feature vector.

5. The watermark extraction method according to claim 4, wherein the encoder in the second identification model comprises a plurality of sub-encoders connected in sequence, and the encoding the each information block among the plurality of the information blocks by the encoder in the second identification model comprises:
processing an input feature vector of an i-th sub-encoder by the i-th sub-encoder; and
taking an output feature vector of the i-th sub-encoder as an input feature vector of an (i+1)-th sub-encoder, wherein an input feature vector of a first sub-encoder is an embedded feature vector of the each information block, and an output feature vector of a n-th sub-encoder is the second encoding feature vector, where 1≤i<N, and N is a total number of the sub-encoders.

6. The watermark extraction method according to claim 5, wherein each sub-encoder among the plurality of the sub-encoders comprises a plurality of self-attention models, and the processing the input feature vector of the i-th sub-encoder by the i-th sub-encoder comprises:
processing the input feature vector of the i-th sub-encoder by each self-attention model among the plurality of the self-attention models in the i-th sub-encoder to obtain a sub-feature vector, thereby obtaining a plurality of sub-feature vectors; and
fusing the plurality of the sub-feature vectors to obtain the output feature vector of the i-th sub-encoder.

7. The watermark extraction method according to claim 6, wherein the fusing the plurality of the sub-feature vectors comprises:
splicing the plurality of sub-feature vectors.

8. The watermark extraction method according to claim 1, wherein the deforming the image to be processed comprises:
determining an affine transformation parameter according to the current position relationship of the at least part of positioning blocks and the reference position relationship of the at least part of positioning blocks; and
performing affine transformation on the image to be processed according to the affine transformation parameter to obtain the deformed image to be processed.

9. A model training method, comprising:
acquiring a sample image embedded with a watermark, wherein the watermark comprises a plurality of positioning blocks and a plurality of information blocks;
identifying the sample image by a first identification model to identify at least part of positioning blocks among the plurality of the positioning blocks;
training the first identification model according to the at least part of positioning blocks and positioning block labeling information;
deforming the sample image to obtain a deformed sample image according to a current position relationship of the at least part of positioning blocks and a reference position relationship of the at least part of positioning blocks in a case where a number of the at least part of positioning blocks is greater than a preset threshold, wherein in a deformed sample image, a current position relationship of the plurality of the positioning blocks is consistent with a reference position relationship of the plurality of the positioning blocks;
extracting the plurality of the information blocks from the deformed sample image according to the reference position relationship of the plurality of the positioning blocks;
identifying the plurality of the information blocks by a second identification model to obtain the watermark carried by the plurality of the information blocks; and
training the second identification model according to the watermark and watermark labeling information.

10. The model training method according to claim 9, wherein the identifying the sample image by the first identification model comprises:
preprocessing the sample image to obtain a plurality of enhanced sample images, wherein the preprocessing comprises at least one of color temperature adjustment or saturation adjustment; and
identifying each enhanced sample image among the plurality of the enhanced sample images by the first identification model.

11. (canceled)

12. The model training method according to claim 9, wherein the identifying the plurality of the information blocks by the second identification model comprises:
sorting the plurality of the information blocks in a plurality of different orders to obtain a plurality of queues; and
identifying a plurality of information blocks in each queue among the plurality of the queues by the second identification model to obtain the watermark.

13. A watermark addition method, comprising:
generating a watermark, wherein the watermark comprises a plurality of positioning blocks and a plurality of information blocks, wherein the plurality of the positioning blocks have a reference position relationship, and the plurality of the information blocks carry watermark to be added; and
embedding the watermark in a designated area of a target image.

14. The watermark addition method according to claim 13, wherein
the plurality of the information blocks comprise a plurality of first information blocks for representing a first character and a plurality of second information blocks for representing a second character.

15. The watermark addition method according to claim 14, wherein the embedding the watermark in the designated area of the target image comprises:
overlaying the watermark with an image in the designated area of the target image.

16. The watermark addition method according to claim 15, wherein
colors of the positioning block, the first information block and the second information block are colors insensitive to human vision and are different from each other; or colors of any two blocks in the positioning block, the first information block and the second information block are insensitive to human vision and are different from each other, and one block in the positioning block, the first information block and the second information block except for the any two blocks is colorless.

17. (canceled)

18. The watermark addition method according to claim 14, wherein the designated area comprises a first sub-area corresponding to the plurality of the positioning blocks, a second sub-area corresponding to the plurality of the first information blocks and a third sub-area corresponding to the plurality of the second information blocks, and the embedding the watermark in the designated area of the target image comprises:
selecting two sub-areas from the first sub-area, the second sub-area and the third sub-area;
determining a first parameter value according to an average gray value of pixels of one sub-area of the two sub-areas;
adjusting a gray value of each pixel in the one sub-area of the two sub-areas according to the first parameter value;
determining a second parameter value according to an average gray value of pixels of the other sub-area of the two sub-areas, wherein the second parameter value is different from the first parameter value; and
adjusting a gray value of each pixel in the other sub-area of the two sub-areas according to the second parameter value.

19. The watermark addition method of claim 18, wherein the embedding the watermark in the designated area of the target image comprises:
determining a third parameter value according to an average gray value of pixels of a remaining sub-area in the first sub-area, the second sub-area and the third sub-area except for the two sub-areas, wherein the third parameter value is different from the first parameter value and the second parameter value; and
adjusting a gray value of each pixel in the remaining sub-area according to the third parameter value.

20. The watermark addition method according to claim 13, wherein the designated area comprises a plurality of sub-areas, and the embedding the watermark in the designated area of the target image comprises:
embedding the watermark in each sub-area among the plurality of sub-areas.

21. An electronic device comprising:
a processor; and
a memory coupled to the processor, storing program instructions which, when executed by the processor, cause the processor to implement the method according to claim 1.

22. A non-transient computer-readable storage medium, wherein the computer-readable storage medium stores computer instructions which, when executed by a processor, implement the method according to claim 1.
